(19) United States
(12) Patent Application Publication
(10) Pub. No.: US 2012/0161905 A1
(43) Pub. Date: Jun. 28, 2012

(54) RESONANT ELEMENT AND RESONATOR FILTER WITH FREQUENCY-TUNABLE LAYER STRUCTURE AND METHOD OF TUNING FREQUENCY OF RESONATOR FILTER

(75) Inventors: Won Hui LEE, Daejeon (KR); Tae Jin CHUNG, Daejeon (KR)

(73) Assignee: ELECTRONICS AND TELECOMMUNICATIONS RESEARCH INSTITUTE, Daejeon (KR)

(21) Appl. No.: 13/294,308

(22) Filed: Nov. 11, 2011

(30) Foreign Application Priority Data
Dec. 22, 2010 (KR) 10-2010-0132892

(51) Int. Cl. H01P 1/207

(52) U.S. Cl. 333/209

(57) ABSTRACT

Provided are a resonant element and resonator filter with a frequency tunable layer structure and a method of tuning a frequency of a resonator filter. A resonant element with a frequency-tunable layer structure includes a waveguide layer through which an electric wave is transmitted, a frequency adjustment layer positioned on at least one of an upper layer and a lower layer of the waveguide layer, and configured to change at least one of a height and a structure of the resonant element, and an outer layer positioned outwardly from the waveguide layer and the frequency adjustment layer, and constituting an external structure of the resonant element. Consequently, it is possible to reduce economic and temporal waste caused by remanufacturing a resonator filter because the frequency characteristics of the manufactured resonator filter do not coincide with designed frequency characteristics.

### CLAIM FOR PRIORITY

This application claims priority to Korean Patent Application No. 10-2010-0132892 filed on Dec. 22, 2010 in the Korean Intellectual Property Office (KIPO), the entire contents of which are hereby incorporated by reference.

### BACKGROUND

1. Technical Field

Example embodiments of the present invention relate in general to a frequency-tunable resonator filter and a method of tuning a frequency using the same, and more specifically to a resonant element and resonator filter with a frequency tunable layer structure and a method of tuning a frequency of a resonator filter.

2. Related Art

A high quality bandpass filter, a duplexer and the like of a microwave band are used for next generation mobile communication and satellite communication as essential core parts. Requirements of parts used for mobile communication and radio communication systems include ultra-miniaturization, high performance, low cost and the like, and have been satisfied with the development of technology such as a microwave integrated circuit (MIC) and a monolithic microwave integrated circuit (MMIC). A resonator used for a microwave communication system includes a planar resonator, a dielectric resonator, a cavity resonator and the like.

A resonator filter or a dielectric resonator filter is applied to almost all radio transmission/reception communication apparatuses, such as mobile communication base stations and repeaters, satellite communication systems and radio communication systems, due to low insertion loss and high output. The resonator filter transfers a signal of a specific frequency band through inductive and capacitive coupling caused by interaction among a resonator or dielectric, an iris, and a tuning screw.

A resonator filter of a microwave band is manufactured through pre-design and post-manufacturing. Due to a manufacturing error in the manufacturing process and conductor loss, a change occurs between a design frequency and a cut-off frequency of a manufactured resonator filter. Therefore, in order to finely adjust the design frequency, frequency tuning is performed using a tuning screw. At this time, the distance between the resonator and the tuning screw and a root area of the tuning screw serve as capacitance and inductance, thereby finely tuning the cut-off frequency.

Korean Patent Publication No. 2009-0080761 (entitled “Radio Frequency Filter and Tuning Structure Therein”) discloses a method of tuning a frequency of a radio frequency (RF) filter using a tuning screw.

In the RF filter, a space in a housing may be divided into a plurality of receiving spaces, and resonators of metal resonant bars may be installed in the divided receiving spaces, respectively. The housing is sealed by a cover provided with a tuning screw at a position corresponding to the corresponding resonator, so that a frequency passing through the filter can be tuned.

According to the tuning structure of the RF filter, a frequency to be filtered is adjusted using a tuning screw inserted into a screw hole formed in the housing opposite to the upper portion of the resonator at a corresponding position of the upper portion of the resonator. Using such a frequency tuning method, adaptive and efficient tuning can be performed according to temperature conditions.

Since existing technology for tuning a frequency is mainly available in microwave and millimeter wave bands and the size of a resonator used in a high frequency band such as terahertz is very small, if a tuning screw is inserted, a higher order mode occurs. Furthermore, since a frequency shift range is wide, fine tuning is difficult.

### SUMMARY

Accordingly, example embodiments of the present invention provide a resonant element included in a very small frequency-tunable resonator filter capable of finely tuning a cutoff frequency.

Example embodiments of the present invention also provide a very small frequency-tunable resonator filter capable of finely tuning a cutoff frequency.

Example embodiments of the present invention also provide a method of tuning a frequency using a very small frequency-tunable resonator filter capable of finely tuning a cutoff frequency.

In some example embodiments, a resonant element with a frequency-tunable layer structure includes: a waveguide layer through which an electric wave is transmitted; a frequency adjustment layer positioned on at least one of an upper layer and a lower layer of the waveguide layer, and configured to change at least one of a height and a structure of the resonant element; and an outer layer positioned outwardly from the waveguide layer and the frequency adjustment layer, and constituting an external structure of the resonant element. The frequency adjustment layer may include at least two layers, and the number of layers may be controlled to control frequency characteristics of the resonant element. The frequency adjustment layer may change a shape of a hole of the resonant element to control frequency characteristics of the resonant element. The frequency adjustment layer may include an upper frequency adjustment layer positioned on the waveguide layer, and a lower frequency adjustment layer positioned under the waveguide layer. The resonant element with the frequency-tunable layer structure may have a cavity resonator structure or a dielectric loaded resonator structure. The resonant element with the frequency-tunable layer structure may be used in a terahertz frequency band ranging from approximately 100 GHz to approximately 10 THz.

In other example embodiments, a resonator filter with a frequency-tunable layer structure includes at least two resonant elements coupled with each other, wherein each resonant element includes: a waveguide layer through which an electric wave is transmitted; a frequency adjustment layer positioned on at least one of an upper layer and a lower layer of the waveguide layer, and configured to change at least one of a height and a structure of the resonant element; and an outer layer positioned outwardly from the waveguide layer and the frequency adjustment layer, and constituting an external structure of the resonant element. The frequency adjustment layer may include at least two layers, and the number of layers may be controlled to control frequency characteristics of the resonant element. The frequency adjustment layer may change a shape of a hole of the resonant element to control frequency characteristics of the resonant element. The frequency adjustment layer may include an upper frequency adjustment layer positioned on the waveguide layer, and a lower frequency adjustment layer positioned under the waveguide layer. The resonant elements may have a cavity resonator structure or a dielectric loaded resonator structure. The resonant elements may be used in a terahertz frequency band ranging from approximately 100 GHz to approximately 10 THz. The resonant elements may be formed to have a block structure that can be coupled with one another, and may be coupled with or separated from the resonator filter to change frequency bandwidth characteristics, frequency cutoff characteristics, and frequency passband ripple characteristics of the resonator filter.

In still other example embodiments, a method of tuning a frequency of a resonator filter includes: calculating a frequency characteristic error based on frequency characteristics of the resonator filter; and tuning the frequency of the resonator filter using at least one of a method of changing the number of resonant elements by separating the resonant elements included in the resonator filter from the resonator filter or coupling the resonant elements with the resonator filter and a method of changing at least one of heights and structures of the resonant elements included in the resonator filter. Tuning the frequency of the resonator filter may include controlling the number of layers of a frequency adjustment layer included in the resonant element to control frequency characteristics of the resonant element. Tuning the frequency of the resonator filter may include changing a shape of a hole of the resonant element to control frequency characteristics of the resonant element.

### BRIEF DESCRIPTION OF DRAWINGS

Example embodiments of the present invention will become more apparent by describing in detail example embodiments of the present invention with reference to the accompanying drawings, in which:

FIG. 1 is a perspective view of a frequency-tunable resonator filter according to an example embodiment of the present invention;

FIGS. 2A and 2B are a plan view and a sectional view of a resonator obtained by coupling resonant elements with one another according to an example embodiment of the present invention;

FIG. 3 is a sectional view of the frequency-tunable resonator filter shown in FIG. 1 according to an example embodiment of the present invention;

FIG. 4 is a plan view of the frequency-tunable resonator filter shown in FIG. 1 according to an example embodiment of the present invention

FIG. 5 is a perspective view of a frequency-tunable resonator filter according to an example embodiment of the present invention; and

FIG. 6 is a flowchart showing a method of tuning the frequency of a resonator filter according to an example embodiment of the present invention.

### DESCRIPTION OF EXAMPLE EMBODIMENTS

Example embodiments of the present invention are disclosed herein. However, specific structural and functional details disclosed herein are merely representative for purposes of describing example embodiments of the present invention, however, example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It should also be noted that in some alternative implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved.

Hereinafter, example embodiments of the present invention will be described with reference to appended drawings. The same reference numerals are used to designate the same elements in the drawings, and redundant description of the same elements will not be repeated.

Hereinafter, in example embodiments of the present invention, a first layer may be termed an “upper outer structure,” a fifth layer may be termed a “lower outer structure,” a second layer may be termed a “lower frequency adjustment layer,” a fourth layer may be termed an “upper frequency adjustment layer,” and a third layer may be termed a “waveguide layer.”

When the second layer and the fourth layer are integrated into one layer, the second layer and the fourth layer may be termed a “frequency adjustment layer.”

Furthermore, a term “resonant element” used in example embodiments of the present invention represents a layer structure having one hole. That is, in order to realize a resonator filter according to example embodiments of the present invention, it is possible to use a structure in which at least one resonant element is coupled to the resonator filter. Since one resonant element may also serve as a resonator filter, the resonant element is included in the concept of a resonator filter.

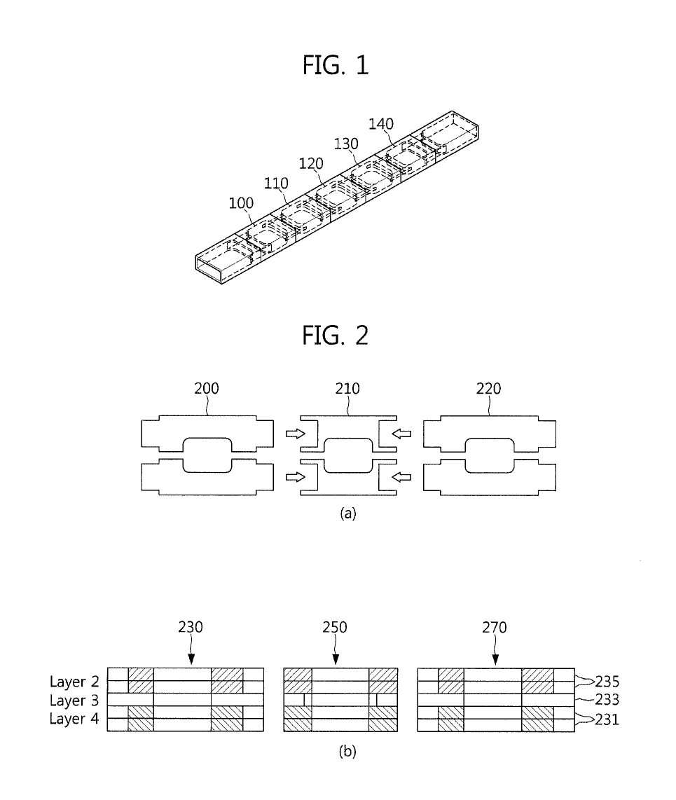

FIG. 1 is a perspective view of a tunable resonator filter according to an example embodiment of the present invention.

Referring to FIG. 1, the resonator filter includes five resonant elements 100, 110, 120, 130 and 140, and the resonant elements may be individually separated from the resonator filter.

The number of resonant elements included in the resonator filter shown in FIG. 1 according to the example embodiment of the present invention is for illustrative purposes only, and any resonator filter to which at least one resonant element is coupled according to the example embodiment of the present invention is also included in the scope of the claims of the present invention.

For the purpose of convenience, FIG. 1 shows a structure in which the resonant elements constituting the resonator filter are linearly arranged. However, according to an example embodiment of the present invention, the resonant elements may be arranged in a two-stage structure or in an irregular shape other than the linear structure, and this arrangement of the resonant elements is also included in the scope of the claims of the present invention.

According to an example embodiment of the present invention, it is possible to control bandwidth characteristics, cutoff characteristics, and passband ripple characteristics by changing the number of resonant elements included in the resonator filter.

Central hollow portions (referred to as holes) of the resonant elements 100, 110, 120, 130 and 140 may be manufactured in a cylindrical or polygonal block shape, or manufactured by inserting a dielectric into the holes.

The resonant elements 100, 110, 120, 130 and 140 included in the resonator filter may be separated from one another, or coupled to one another. Consequently, when a cutoff frequency estimated in a design does not coincident with a frequency after manufacturing the resonator filter, only the shape or height of a part of the resonant elements included in the resonator filter is machined again without machining the resonator filter and inserted again into the resonator filter, so that the cutoff frequency can be tuned.

The resonant element may have a plurality of layers, and a height of a part of the layers, which may change the height of the resonant element, is changed, so that the cutoff frequency can be tuned.

In the resonator filter according to the example embodiment of the present invention, the characteristics of the resonator can be changed in a structure in which a tuning screw may not be inserted because the size of the resonator is small. Since the size of the resonator filter is very small, the resonator filter may be used as a resonator filter in a terahertz band (100 GHz to 10 THz) in which a tuning screw is not available. In addition, since the resonator filter is also available in a band equal to or less than the terahertz band, or a millimeter wave frequency band, the use of the example embodiment of the present invention in such a frequency band is also included in the scope of the claims of the present invention.

The resonant elements included in the resonator filter may be formed to have a block structure that can be coupled with one another. The resonant elements are coupled with or separated from the resonator filter, so that the number of resonant elements can be controlled. By controlling the number of resonant elements included in the resonator filter, it is possible to change frequency bandwidth characteristics, frequency cutoff characteristics, and frequency passband ripple characteristics of the resonator filter.

FIGS. 2A and 2B are a plan view and a sectional view of a resonator obtained by coupling the resonant elements with one another according to the example embodiment of the present invention.

Referring to FIGS. 2A and 2B, the resonant elements constituting the resonator filter may be manufactured in a structure in which the resonant elements may be coupled with one another.

The coupling structure of the resonant elements shown in FIGS. 2A and 2B is for illustrative purposes only. According to the example embodiment of the present invention, the resonant elements can be coupled with one another using other coupling structures except for the above coupling structure, thereby realizing the resonator filter. Also, the resonator filter is included in the scope of the claims of the present invention.

FIGS. 2A and 2B show a method by which first resonant elements 200 and 230, second resonant elements 210 and 250, and third resonant elements 220 and 270 are generated and coupled with one another.

The first resonant elements 200 and 230 and the third resonant elements 220 and 270 are provided with coupling parts having a male screw structure, and the second resonant elements 210 and 250 are provided with coupling parts having a female screw structure, so that the respective resonant elements can be individually separated from one another, or coupled with one another.

Each of the first to third resonant elements may have five layers. Since the five-layer structure is an example embodiment of the present invention, the resonant elements may have a different number of layers without departing from the scope of the present invention in which the frequency characteristics of the resonator filter are controlled by changing the height and structure of a specific layer included in the resonant element. Such a structure of the resonant element is also included in the scope of the claims of the present invention.

First and fifth layers may be a structure for forming the outer periphery of the resonant element. The first layer for forming the outer periphery of the resonant element may be termed an “upper outer structure,” and the fifth layer for forming the outer periphery of the resonant element may be termed a “lower outer structure.”

Second and fourth layers 235 and 231 are layers capable of changing the height and structure of layers, and may be termed a “frequency adjustment layer.”

According to a method of controlling the height of the resonant element, the frequency adjustment layers may be provided in the form of a thin film and stacked. According to a method of changing a structure to control a frequency, it is possible to tune the cutoff frequency of a filter while controlling patterns according to thin films of the second layer 235 and the fourth layer 231. For example, if the diameter of an empty space of a resonant element is 1 mm and there is no desired cutoff frequency of a filter, the diameter of the empty space (a layer pattern) is changed to 0.8 mm, 0.9 mm, 1.1 mm, 1.2 mm and the like, resulting in a change in the characteristics of the resonator filter. Also, the shape of the pattern is changed to a rectangle, a circle, and a polygon, resulting in the frequency tuning of the resonator filter.

Without using a method by which two layers (the second layer 235 and the fourth layer 231) are used as the frequency adjustment layers, the height and structure of a single layer (e.g., the second layer 235 rather than the fourth layer 231) may be changed to tune a frequency, or a structure (i.e., a structure including an additional frequency adjustment layer) of two or more layers may be used to tune a frequency.

A third layer 233 serves as a waveguide through which an electric wave is transmitted, and constitutes a filter structure. The width and height of the third layer 233 may be determined as a standard waveguide size at a design frequency of a filter. The third layer may be termed a “waveguide layer.”

The first to third resonant elements have a structure in which the third to fifth layers are coupled with one another.

For simplification of the drawings, the first layer and the fifth layer are not shown in FIG. 2B. However, each resonant element may have a structure in which two layers are added to the layers as the top and bottom layers.

The order of the layers may be changed, and the resonant element may be realized by further adding or excluding a specific layer without departing from the scope of the present invention. Such a structure of the resonant element is also included in the scope of the claims of the present invention.

According to the example embodiment of the present invention, in order to realize a resonator filter, at least one resonant element may be coupled with the resonator filter. Furthermore, the structure of the resonator filter including at least one resonant element according to the example embodiment of the present invention is included in the scope of the claims of the present invention.

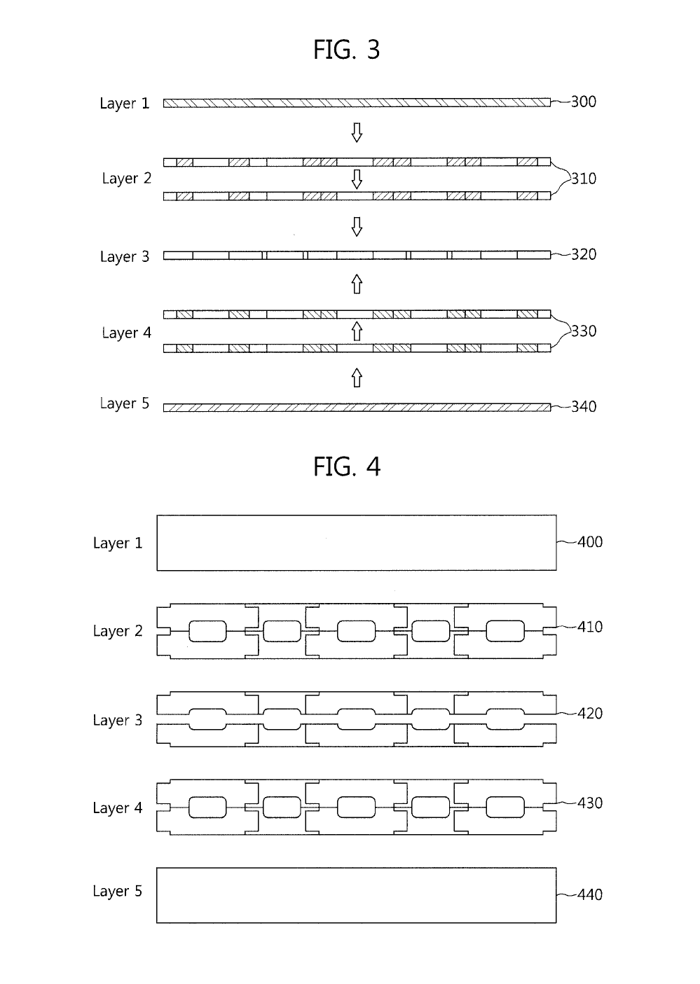

FIG. 3 is a sectional view of the frequency-tunable resonator filter shown in FIG. 1 according to the example embodiment of the present invention.

Referring to FIG. 3, the tunable resonator filter may include a plurality of layers.

In the example embodiment of the present invention below, for the purpose of convenience, the resonator filter including five layers is disclosed. However, there is no limitation on the number of layers constituting the resonator filter within the scope of the present invention. For example, in order to change the height and structure of a resonator, the number of layers constituting the resonator filter may be increased or decreased.

When the size of a resonator is very small, it is difficult to use a method of tuning a frequency using a frequency-tunable screw.

For example, since a significant variation occurs in a cutoff frequency when the diameter of a one-stage resonator of a 120 GHz bandpass filter is approximately 2.5 mm, and a circular column with a diameter of 0.1 mm is inserted into a resonator, it is difficult to tune the cutoff frequency using a tuning screw. In this regard, it is possible to tune a frequency using a method of controlling the heights of the layers by realizing a resonator filter to have a plurality of layers, instead of using a frequency-tunable screw.

A first layer 300 and a fifth layer 340, which constitute a resonator filter, may serve as an outer structure of the filter and may be formed of a conductive material.

A third layer 320 serves as a waveguide through which an electric wave is transmitted, and constitutes a filter structure.

A second layer 310 and a fourth layer 330 may be provided in the form of a very thin plate, and the height of a resonator is controlled using the second layer 310 and the fourth layer 330, so that the frequency characteristics of the resonator filter can be controlled.

Also, it is possible to tune the frequency characteristics of the filter using a method of changing the shape of the resonant element of the second layer 310 and the fourth layer 330, as well as the method of changing the height.

For example, the diameter of a hole is changed, or the shape of the hole is changed to a rectangle, a circle, a polygon and the like, resulting in the tuning of the frequency characteristics.

The second layer 310 and the fourth layer 330 may be generated without a structural gap while closely making contact with each other such that no error occurs in filter characteristics when the second layer 310 and the fourth layer 330 are coupled with each other.

In the example embodiment of the present invention, an example in which the second layer 310 and the fourth layer 330 for changing the frequency of the resonator filter by changing the height and structure of a layer are positioned inwardly from the outer structures (the first layer 300 and the fifth layer 340) to realize the resonator filter, and positioned outwardly from the third layer 320 serving as a waveguide through which an electric wave is transmitted has been described. However, the positions of the second layer 310 and the fourth layer 330 are not limited to the specific positions shown in FIG. 2 and the second layer 310 and the fourth layer 330 may be formed to have one integrated structure without departing from the scope of the present invention in which the frequency characteristics of the resonator filter with a layer structure are changed by changing the height and structure of a specific layer.

The width and height of the third layer 320 may be determined as a standard waveguide size at a design frequency of a filter.

The tunable resonator filter according to the example embodiment of the present invention may be generated to have a layer structure.

For example, according to a method of forming a resonator filter in a sequential manner, a first layer constituting the outer periphery of the resonator filter is formed, a second layer for determining the frequency characteristics of the resonator filter is stacked on the first layer, and a third layer serving as a waveguide is sequentially stacked on the second layer, thereby manufacturing the resonator filter.

However, instead of the sequential manufacturing method, it may be possible to use a method in which a second layer, a third layer and a fourth layer are preferentially coupled with one another, and a first layer and a fifth layer, which constitute the outer structures of a resonator filter, are then coupled with a coupling structure of the second layer, the third layer and the fourth layer.

FIG. 4 is a plan view of the frequency-tunable resonator filter shown in FIG. 1 according to the example embodiment of the present invention.

In FIG. 4, for the purpose of convenience, the resonator filter including five layers is disclosed. However, there is no limitation on the number of layers constituting the resonator filter within the scope of the present invention. For example, in order to change the height and structure of a resonator, the number of layers constituting the resonator filter may be changed.

The structure of FIG. 4 corresponds to a planar structure of a second layer 235, a third layer 233, and a fourth layer 231 which are shown in FIG. 2.

The first layer 400 and the fifth layer 440 serve as the outer structures of the filter and may be formed of a conductive material.

The third layer 420 may serve as a waveguide through which an electric wave is transmitted, and constitute a filter structure. Here, a resonator may have a cylindrical or polygonal block shape.

The heights and structures of the second layer 410 and the fourth layer 430 are controlled in order to tune the frequency of a resonator. That is, the heights of layers constituting the second layer 410 and the fourth layer 430 and the structures of the second layer 410 and the fourth layer 430 are changed, resulting in the tuning of the cutoff frequency of the resonator. Here, a hole may have a cylindrical or polygonal block shape, or a dielectric may be inserted into the hole.

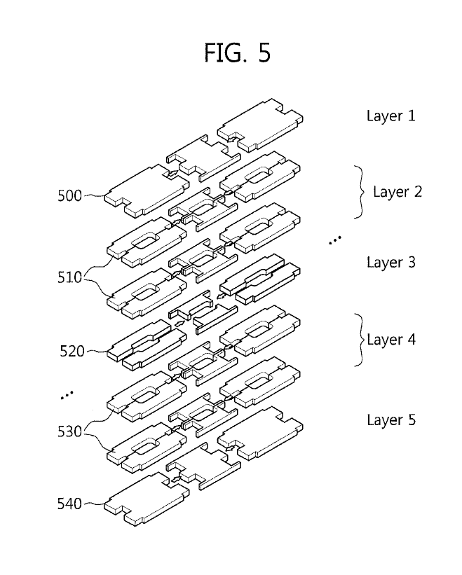

FIG. 5 is a perspective view of a frequency-tunable resonator filter according to the example embodiment of the present invention.

Referring to FIG. 5, respective layers constituting a resonant element are separated from one another.

A first layer 500 and a fifth layer 540 constitute the upper and lower portions of the resonant element, wherein the first layer 500 is an outer structure covering the upper end of the resonant element and the fifth layer 540 is an outer structure covering the lower end of the resonant element included in the resonator filter.

Each of a second layer 510 and a fourth layer 530 may include a plurality of layers. It is possible to control the height of the resonant element by excluding a part of the layers constituting the second layer 510 or the fourth layer 530. According to a method of controlling a frequency by changing the structure of a hole included in the resonant element, it is possible to tune the cutoff frequency of the filter while controlling patterns according to thin films of the second layer 510 and the fourth layer 530. For example, if the diameter of an empty space of the resonant element is 1 mm and there is no desired cutoff frequency of the filter, the diameter of the empty space (a layer pattern) is changed to 0.8 mm, 0.9 mm, 1.1 mm, 1.2 mm and the like, resulting in a change in the characteristics of the resonator filter. Also, the shape of the pattern is changed to a rectangle, a circle, and a polygon, resulting in the frequency tuning of the resonator filter.

The third layer 520 may serve as a waveguide through which an electric wave is transmitted, and constitute a filter structure.

The resonant elements included in the resonator filter may be formed to have a block structure that can be coupled with one another. The resonant elements are coupled with or separated from the resonator filter, so that the number of resonant elements can be controlled. By controlling the number of resonant elements included in the resonator filter is controlled, it is possible to control frequency bandwidth characteristics, frequency cutoff characteristics, and frequency passband ripple characteristics of the resonator filter.

That is, according to the example embodiment of the present invention, the resonant elements constituting the resonator are coupled with one another, resulting in a change in the number of resonant elements constituting the resonator. Based on the change in the number of resonant elements, it is possible to control various variables such as a bandwidth of the filter, cutoff characteristics and insertion loss.

According to the example embodiment of the present invention, the resonant structure with a multi-layer structure disclosed in the present invention can be coupled with an existing resonant structure. That is, a resonant structure including a part of the tunable resonator with a multi-layer structure disclosed in the present invention is included in the scope of the claims of the present invention.

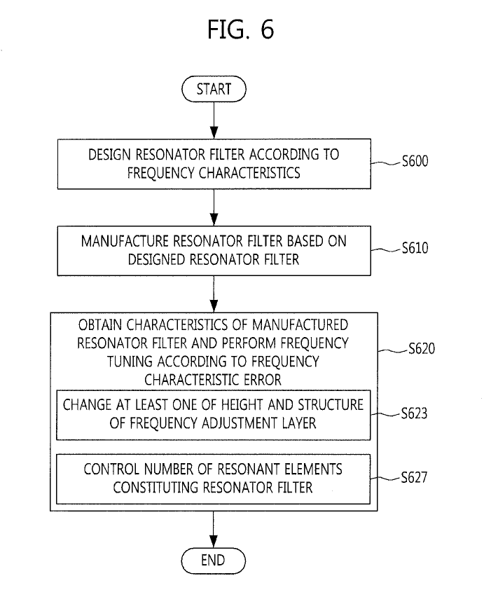

FIG. 6 is a flowchart showing a method of tuning the frequency of a resonator filter according to an example embodiment of the present invention.

Referring to FIG. 6, a resonator filter may be designed according to frequency characteristics (operation S600).

The height of the resonator filter, the structure of the resonator filter, the number of resonant elements constituting the resonator filter, and the like are estimated in order to obtain desired filtering characteristics of the resonator filter.

For example, in order to obtain the desired filtering band characteristics, the resonator filter may be designed by changing the height of the resonant element and the shape of a hole for realizing the resonator filter, or changing the number of resonant elements constituting the resonator filter.

The resonator filter may be manufactured based on the designed resonator filter (operation S610).

Various methods may be used in order to manufacture the resonator filter. For example, it is possible to use a method of sequentially stacking first to fifth layers, or a method of manufacturing first and fifth layers, which constitute outer structures of the resonator filter, to be coupled with each other, and separately manufacturing second and fourth layers including resonant elements and a waveguide structure to couple the first and fifth layers with the second and fourth layers. That is, a resonator filter manufacturing method is not limited to a specific manufacturing method without departing from the scope of the invention.

In manufacturing the frequency-tunable resonator filter, frequency adjustment layers may be separably manufactured such that the heights of the layers and the structure of holes can be changed.

The characteristics of the manufactured resonator filter may be obtained and a specific structure of the resonant element may be changed according to a frequency characteristic error (operation S620).

In detail, the frequency characteristics of the resonator filter are changed using a method of changing the height and structure of the frequency adjustment layer included in the resonant element or changing the number of resonant elements constituting the resonator filter. In this way, a generated error is reduced, and the frequency characteristics of an initially designed resonator filter can be obtained.

As described above, when a tuning screw cannot be inserted because the size of a resonant element is very small, the frequency-tunable resonator filter according to an example embodiment of the present invention is manufactured using a structure in which layers are manufactured and coupled with one another and a structure in which resonant elements are designed and coupled with one another, thereby enabling frequency tuning even if the size of the resonant element is very small. Consequently, it is possible to reduce economic and temporal waste caused by remanufacturing a resonator filter because the frequency characteristics of the manufactured resonator filter do not coincide with designed frequency characteristics.

While the example embodiments of the present invention and their advantages have been described in detail, it should be understood that various changes, substitutions and alterations may be made herein without departing from the scope of the invention.

What is claimed is:

1. A resonant element with a frequency-tunable layer structure, comprising:
a waveguide layer through which an electric wave is transmitted in the resonant element;
a frequency adjustment layer positioned on at least one of an upper layer and a lower layer of the waveguide layer, and configured to change at least one of a height and a structure of the resonant element; and
an outer layer positioned outwardly from the waveguide layer and the frequency adjustment layer, and constituting an external structure of the resonant element.

2. The resonant element of claim 1, wherein the frequency adjustment layer includes at least two layers, and the number of layers is controlled to control frequency characteristics of the resonant element.

3. The resonant element of claim 1, wherein the frequency adjustment layer changes a shape of a hole of the resonant element to control frequency characteristics of the resonant element.

4. The resonant element of claim 1, wherein the frequency adjustment layer includes:
an upper frequency adjustment layer positioned on the waveguide layer; and
a lower frequency adjustment layer positioned under the waveguide layer.

5. The resonant element of claim 1, wherein the resonant element has a cavity resonator structure or a dielectric loaded resonator structure.

6. The resonant element of claim 1, wherein the resonant element is used in a terahertz frequency band ranging from approximately 100 GHz to approximately 10 THz.

7. A resonator filter with a frequency-tunable layer structure, comprising:
at least two resonant elements coupled with each other,
wherein each resonant element includes:
a waveguide layer through which an electric wave is transmitted;
a frequency adjustment layer positioned on at least one of an upper layer and a lower layer of the waveguide layer, and configured to change at least one of a height and a structure of the resonant element; and
an outer layer positioned outwardly from the waveguide layer and the frequency adjustment layer, and constituting an external structure of the resonant element.

8. The resonator filter of claim 7, wherein the frequency adjustment layer includes at least two layers, and the number of layers is controlled to control frequency characteristics of the resonant element.

9. The resonator filter of claim 7, wherein the frequency adjustment layer changes a shape of a hole of the resonant element to control frequency characteristics of the resonant element.

10. The resonator filter of claim 7, wherein the frequency adjustment layer includes:
an upper frequency adjustment layer positioned on the waveguide layer; and
a lower frequency adjustment layer positioned under the waveguide layer.

11. The resonator filter of claim 7, wherein the resonant elements have a cavity resonator structure or a dielectric loaded resonator structure.

12. The resonator filter of claim 7, wherein the resonant elements are used in a terahertz frequency band ranging from approximately 100 GHz to approximately 10 THz.

13. The resonator filter of claim 7, wherein the resonant elements are formed to have a block structure that can be coupled with one another, and is coupled with or separated from the resonator filter to change frequency bandwidth characteristics, frequency cutoff characteristics, and frequency passband ripple characteristics of the resonator filter.

14. A method of tuning a frequency of a resonator filter, comprising:
calculating a frequency characteristic error based on frequency characteristics of the resonator filter; and
tuning the frequency of the resonator filter using at least one of a method of changing the number of resonant elements by separating the resonant elements included in the resonator filter from the resonator filter or coupling the resonant elements with the resonator filter and a method of changing at least one of heights and structures of the resonant elements included in the resonator filter.

15. The method of claim 14, wherein, tuning the frequency of the resonator filter includes controlling the number of layers of a frequency adjustment layer included in the resonant element to control frequency characteristics of the resonant element.

16. The method of claim 14, wherein tuning the frequency of the resonator filter includes changing a shape of a hole of the resonant element to control frequency characteristics of the resonant element.
